(19) United States
(12) Patent Application Publication
(10) Pub. No.: US 2003/0076320 A1
(43) Pub. Date: Apr. 24, 2003

(54) Programmable per-pixel shader with lighting support

(76) Inventor: David Collodi, Taylorville, IL (US)

Correspondence Address: William F. Prendergast, Brinks Hofer Gilson & Lione, NBC Tower, Suite 3600, P.O. Box 10395, Chicago, IL, 60610, US

(21) Appl. No.: 10/037,992

(22) Filed: Oct. 18, 2001

(51) Int. Cl. G06T 15/50

(52) U.S. Cl. 345/426

(57) ABSTRACT

A programmable hardware per-pixel shading device for use in real-time 3D graphics applications containing additional asynchronous hardware units to assist in real-time per-pixel lighting. The standard programmable shading unit contains hardware for execution of a user-defined sequence of texture lookup and color blend operations. Programmable shader is assisted by a Vector Generation Unit responsible for generating normalized shading vectors and providing said vectors for use within said programmable shading unit. One or more Vector Shading Units operate in parallel with the programmable shading unit providing hardware accelerated lighting/color calculations and making results available for use in the programmable shading unit.

### BACKGROUND OF THE INVENTION

The present invention relates in general to the field of real-time computer generated graphics hardware. In particular, the present invention relates to the field of per-pixel shading and programmable per-pixel shading within real-time image generation devices. Until recently, most real-time 3D graphics hardware was limited to per-vertex lighting and shading operations, such as Gouraud shading and equivalents. Per-vertex operations, while computationally efficient, tend to produce visual inaccuracies for the lighting of some models and prohibit the rendering of complex surface effects such as true surface curvature, bump mapping, and proper specular reflections. More complicated effects such as Phong shading and bump mapping require that shading operations are done for substantially each drawn pixel on a polygon surface.

Recently, advances in hardware design and processor speed have allowed the application of a limited number of per-pixel effects to be produced in real-time graphics hardware. Recent prior art shading devices have included user-selected multi-texturing capabilities wherein end users were able to direct the texture-blending pipeline to implement a number of per-pixel effects. One such prior art approach is the implementation of Environment Mapped Bump Mapping (EMBM). In a standard EMBM implementation, 2 texture maps are provided—a bump map representing surface perturbation and an environment map representing the light from the surrounding environment. Initially, the bump map value(s) corresponding to the rendered pixel are found by addressing the bump map from interpolated vertex coordinate values. The bump map value(s) are used to compute an environment map address, which is used in turn to address the environment map. The environment map is then taken as the pixel color.

Currently, state of the art pixel shaders allow for a more involved form of user configurability. In some cases, massively parallel pixel architectures are provided consisting of a plurality of pixel processors wherein each processor is capable of performing a user-specified sequence of instructions and mathematical operations on local data to ultimately determine pixel color. In such parallel systems, complex pixel operations can be performed quickly because the number of parallel processors can overcome the time to perform the pixel computations. However, in systems such as these, the hardware cost of supporting multiple general purpose pixel processors ultimately tends to outweigh the benefits of supporting such complex pixel operations. Other state-of-the-art programmable per-pixel shading systems provide a tighter compromise between hardwired functionality and general purpose operation by allowing a limited, user-programmable sequence of specialized pixel operations to be performed within a more traditional pixel rendering pipeline. The Microsoft DirectX8 graphics API presents a standard set of pixel operations for use in the current and future programmable per-pixel shading hardware. Compliant hardware provides for the implementation of said pixel operations, memory units to hold operation result values, and memory to hold a user-defined sequence of operations (program).

Programmable per-pixel shading architectures such as the DirectX8 compliant hardware previously described offer a great deal of user customizability while retaining the speed advantages of dedicated 3D graphics hardware. The architecture, however, provides a number of limitations as well. Most vector operations are typically limited to 8-12 bit accuracy, which is insufficient for some lighting applications such as point lighting and high order specularity. Although programmable per-pixel architectures can be user-defined to perform a variety of operations, they lack parallel processing support for many general-purpose lighting calculations. While programmable architectures allow for the calculation of standard per-pixel surface normal, N, and eye reflection, R, vectors, using the programmable hardware to do so can waste valuable calculation and texture resources and can severely limit the accuracy of the resultant vectors. Likewise, although pixel operations may be used to perform dot product operations for standard diffuse and specular light intensity calculations, the general purpose nature of the per-pixel operations don't lend themselves to the parallelism necessary to process multiple light sources per-pixel. Additionally, general purpose per-pixel operations offer very limited support to point lights and complex specularity functions. There exists a need, therefore, for a programmable per-pixel architecture capable providing parallel processing support for general purpose lighting computations wherein the results of said lighting computations are made available for use within a user-programmable framework.

### BRIEF SUMMARY OF THE INVENTION

The present invention details a hardware extension to a programmable per-pixel shading device. The programmable shading unit is assisted by a lighting sequence unit comprising a vector generation unit, one or more point light units, one or more vector shading units and an optional accumulation unit. The vector generation unit interpolates a surface normal vector, combines it with an optional bump map vector and produces a normalized surface angle vector and a normalized view reflection vector wherein each vector may be used in the programmable unit. The point light unit supplies a normalized point light vector and a fade-off coefficient value to the programmable unit. The vector shading unit performs light-surface dot product calculations, optionally scales the dot product value and uses the scaled dot product to modify a color value. The accumulation unit combines colors into two separate channels: a diffuse color and a specular color and provides said colors for use in the programmable unit.

### BRIEF DESCRIPTION OF SEVERAL VIEWS OF THE DRAWINGS

FIG. 1 is an overview of a preferred embodiment of the present invention.

FIG. 2 depicts the internal components of the Lighting Sequence Unit.

FIG. 2 illustrates the operation of the Vector Generation Unit.

FIG. 3 shows a logic view of the operation of the Point Light Unit.

FIG. 4 illustrates the operation of the Vector Shading Unit.

FIG. 5 illustrates the operation of the Accumulation Unit.

### DETAILED DESCRIPTION OF THE PREFERRED EMBODIMENTS

The present invention performs per-pixel calculations within real-time 3D graphics hardware. Most traditional 3D graphics hardware systems take polygonal (usually triangular) primitives, convert the primitives from world-space to screen-space if necessary, and rasterize the transformed primitive to the screen. During rasterization, the primitive is broken up into a plurality of pixels and each visible pixel is drawn to screen memory. Per-pixel processing units are used to determine pixel color before each pixel is written to screen memory. Per-pixel processing units need not necessarily operate on every pixel in the polygon or the scene as some pixels may be excluded for several reasons including but not limited to occlusion by a nearer surface. The per-pixel processing units generally determine pixel color from a combination of texture map lookups, lighting calculations, and interpolated vertex color values. Prior art per-pixel processors are capable of performing a user-programmable sequence of pixel commands which operate on pixel data to produce the final written color value. The present invention details an improved programmable per-pixel processor able to calculate per-pixel lighting effects faster and more efficiently than prior art implementations.

The present invention seeks to improve lighting performance by the inclusion of dedicated hardware lighting sequence processing while maintaining and enhancing user-customization by allowing said dedicated lighting hardware to provide feedback data to hardware registers which are readable (and potentially writeable) by the user-programmable sequence of pixel operations.

FIG. 1 presents an overview of the logic elements of a per-pixel processor that is a preferred embodiment of the present invention. Said per-pixel processor performs the same general functionality as many prior art per-pixel processors in that it takes, as input, a number of vertex values from a rasterizer, is connected to a texture memory, and ultimately outputs a pixel color. The per-pixel processor, as with prior art approaches, operates on each drawn pixel of the rendered surface primitive. It may be desirable to increase rendering efficiency by providing multiple per-pixel processors running in parallel in order to multiply the pixel throughput. The preferred embodiment detailed herein represents only a single per-pixel processor primarily for the purpose of providing a clear example. As will be recognized by those skilled in the art, multiple copies of the processor detailed herein, as well as those of alternate embodiments, may be used in parallel within a graphics system.

As illustrated by FIG. 1, the preferred embodiment of the present invention is comprised of a Programmable Shading Unit 2 operatively connected to a texture memory 3, a rasterizer 6 and a Lighting Sequence Unit 1. The rasterizer 6, whose operation is well known to those skilled in the art, iterates through the pixels of the current polygon, optionally performs depth buffering operations and provides interpolated vertex values for each pixel. The Programmable Shading Unit 2 is responsible for executing a user-defined sequence of pixel operations. The available operations in a preferred embodiment of the present invention include, but are not limited to, operations for: using a vector value to address a texture, cube, or sphere map, calculation of a 3 or 4 dimensional dot product value, addition and subtraction of scalar and vector values, vector-scalar multiplication and division, and component-wise vector multiplication. Alternate embodiments provide different sets of pixel operations. Said pixel operations are performed on vector and scalar values stored in local memory registers. The Programmable Shading Unit has a number of registers to store scalar and vector values for per-pixel operations. Certain registers are also used to communicate data back and forth from the Lighting Sequence Unit 1. The general embodiment of the Lighting Sequence Unit illustrated in FIG. 1 contains dedicated hardware elements for the generation of normalized surface angle and reflection vectors 8, and hardware elements for the production of light coefficient values, 9, for one or more light sources. Vertex values input from the rasterizer 6 to the Programmable Shading Unit at 7, consist of scalar or vector quantities interpolated from values given at each vertex of said polygonal primitive. The Programmable Shading unit produces a pixel color value at 5, consisting of an RGB color value or an RGBA color-alpha value.

FIG. 6 illustrates a preferred embodiment of the internal operations of the Lighting Sequence Unit. The Vector Generation Unit 71 is responsible for the calculation of a 3-dimensional, unit-length surface normal into vector N and a 3-dimensional, unit-length view reflection vector R. The final N vector value is computed from an interpolated vertex value and is optionally perturbed by a bump map vector. The R vector value is found by reflecting an optionally variable view (eye) vector around the surface normal N vector. One or more Point Light Units 76 provide normalized point light vectors and scalar distance coefficients. One or more Vector Shading Units 74 are responsible for dot product and color scaling operations for light source color and direction vectors. An optional Accumulation Unit 75 sums two separate channels of color values to produce diffuse and specular color values. Communications between the Programmable Unit and the Lighting Sequence Unit are done, in a preferred embodiment, through shared registers. The main goal of the aforementioned hardware units is to provide parallel hardware support for commonly used lighting tasks rather than putting the burden entirely on the Programmable Shading Unit. Hardware lighting units can be assembled in a parallel, pipelined fashion to allow for a completion rate of one pixel per clock cycle. Pipelining the user-programmable operations in the Programmable Shading Unit is more difficult since the sequence of operations is variable. The use of the aforementioned hardware units is advantageous since it removes much of the burden of lighting from the Programmable Shading Unit, freeing the resources to the production of user-defined special effects. The Programmable Unit has even more flexibility since the shading values produced by the various other hardware units are made available for use within the Programmable Unit. This arrangement enhances the user customization of shading routines while providing base per-pixel lighting at rates of 1 pixel per clock cycle or more.

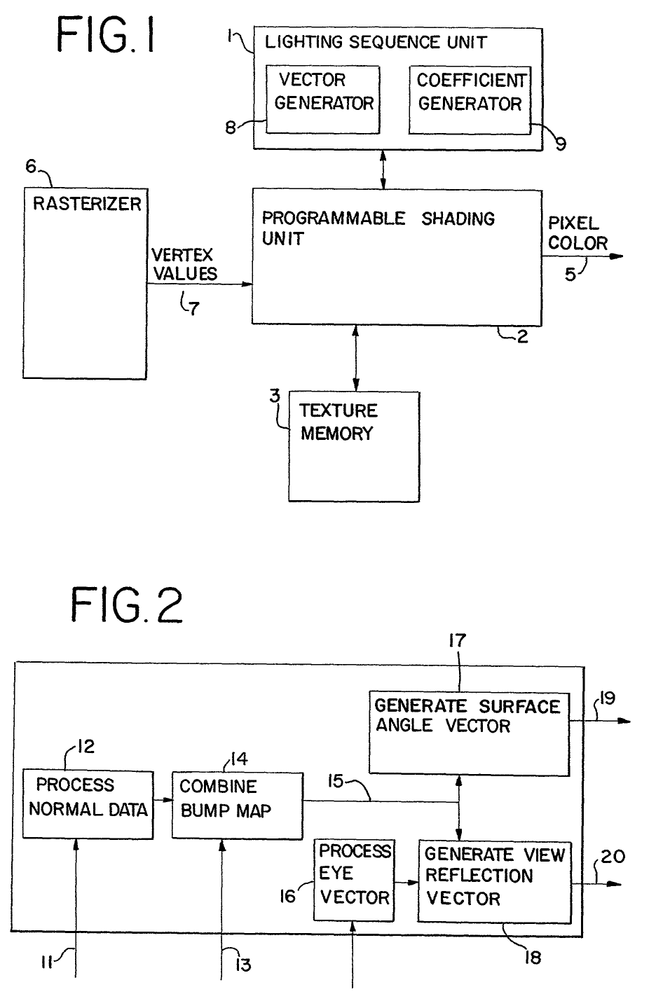

FIG. 2 illustrates the operation of the Vector Generation Unit. At 11, interpolated normal data is received. Several formats of interpolated normal data may be used. In a preferred embodiment, said normal data consists of a 2-dimensional vector interpolated from polygon vertex normal vectors transformed to 2-dimensional vectors by the process described in U.S. patent application filed in the name of David J. Collodi, on Jan. 18, 2001, bearing Ser. No. 09/766,277 and entitled Method and System For Improved Per-Pixel Shading in a Computer Graphics System, the disclosure of which is hereby incorporated by reference. The interpolated normal vector may be in either fixed point or floating point format, but if a fixed point representation is used at least 12 bits of accuracy are assumed. At 12, the interpolated normal vector is received and passed on to the next stage.

At 14, the interpolated normal vector is (optionally) perturbed by a bump-map vector. A bump map vector is passed in at 13. In a preferred embodiment, a 2-dimensional bump map vector is passed in from the Programmable Shading Unit. The Programmable Shading Unit may be configured to generate the bump map vector procedurally or provide the bump map vector as a result of a texture map lookup (or a combined result of multiple texture map lookups) wherein said texture map contains 2-dimensional vector values or the texture map contains height values which are subsequently converted to a two-dimensional vector value. The timing of the Programmable and Lighting Sequence Units must be configured so that the Programmable unit is able to provide a stable value at this stage of execution. Before being combined with the interpolated normal vector, the bump map vector may optionally be transformed by a 2×2 matrix supplied by the Programmable Shading Unit. The bump-map vector b is then combined with said interpolated normal vector n by vector addition to produce composite surface angle vector c where: c=b+n

The c vector is a 2-dimensional vector that represents the surface direction of the current pixel influenced by surface curvature and (optionally) a bump map value. If bump mapping is not used for the current pixel, then the c vector is simply set equal to the n vector. The composite surface vector is output at 15.

At 17, the surface angle vector is generated from the composite surface vector c received at 15. A preferred embodiment uses the component values of vector c to address a 2-dimensional lookup table value wherein said lookup table value is used to produced substantially normalized 3-dimensional surface angle vector, N. The term substantially normalized is used henceforth to describe a vector whose length is in the range of 0.8-1.2, i.e. the vector is approximately unit length. A preferred method for obtaining a substantially normalized 3-dimensional vector from a 2-dimensional lookup table is detailed in the above-referenced U.S. patent application filed in the name of David J. Collodi, on Jan. 18, 2001, and bearing Ser. No. 09/766,277.

Alternate embodiments use dedicated hardware to directly calculate the aforementioned N vector from an interpolated 3-dimensional polygon vertex vector combined with a 3-dimensional bump map vector.

The normalized surface angle vector N is output at 19 for use within the Programmable Shading Unit. Before N is output, it may need to be converted to/from fixed-point format and/or reduced in accuracy dependent on the specification for the Programmable Shading Unit registers and operations. In cases where the N vector reduced in accuracy for output to the Programmable Shading Unit, a full precision copy of N is kept and used for subsequent lighting computations in the Vector Shading Units.

At 16, eye vector information is received. A preferred embodiment receives the screen coordinates for the current pixel which are then converted at 16 into a 2-dimensional offset vector, e. At 18, a normalized view reflection vector is generated. The 2-dimensional offset vector, e, is input as well as composite surface vector c. The e and c vectors are then combined to produce a 2-dimensional reflection vector x, where:

x=2c+e

Next the x vector is used to produce substantially normalized view reflection vector R. The conversion of x to R may be accomplished by the aforementioned procedures used to produce the N vector from the c vector. At 20, the R vector is output to the Programmable Shading Unit. As with the N vector, a lower precision vector may be given to the Programmable Shading Unit and a full precision copy of R may be kept for subsequent operations. Alternate embodiments may use different algorithms for the generation of the R and N vectors provided that they are capable of ensuring a consistent format for each vector.

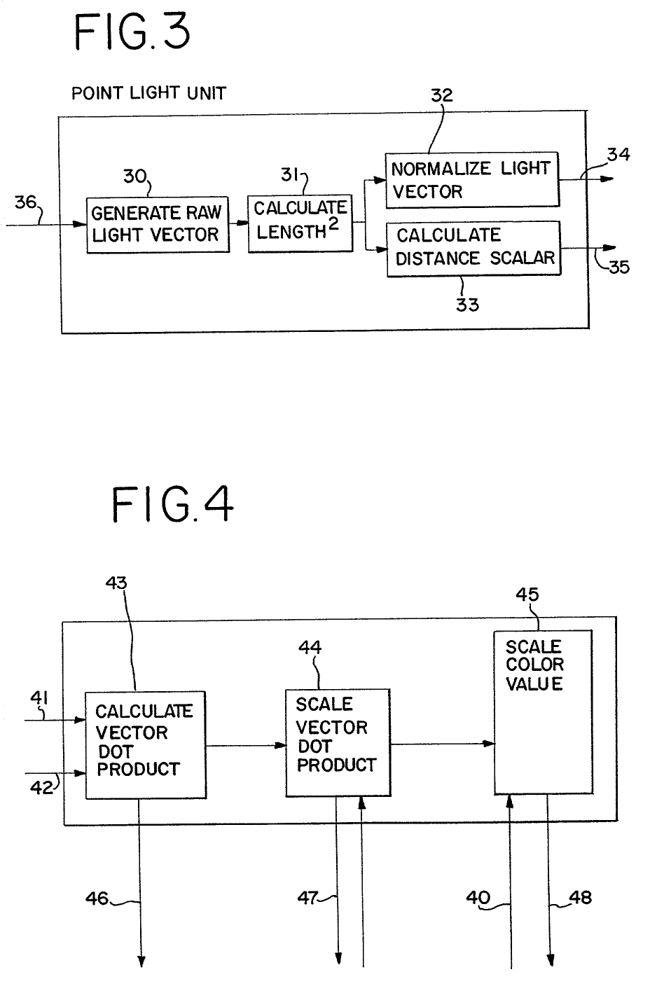

FIG. 3. illustrates the operation of a single Point Light Unit, although a preferred embodiment of the present invention may contain multiple Point Light Units. At 36, point light data is received. In a preferred embodiment, said point light data consists of a 3-dimensional surface position vector, s, representing the position in some fixed coordinate space (such as world space or view space) of the current pixel and a point light position vector, p, representing the position (in the same coordinate space) of a point light. In cases where multiple Point Light Units exist, the same s vector is received by each unit but each unit may receive a separate p vector. At 30, non-normalized point light vector, I, is generated where:

l=p−s

At 31, scalar distance-squared value, d, is calculated where:

d=l·l

At 32, normalized light vector, P, is calculated by normalizing the I vector. The normalization of the I vector is performed, in a preferred manner, by the operations detailed in above-referenced U.S. patent application filed in the name of David J. Collodi, on Jan. 18, 2001, and bearing Ser. No. 09/766,277. However, since the I vector can vary drastically in length, it may be desirable to scale the I vector before normalization. The substantially normalized point light vector, P, is output at 34.

At 33 a distance scalar value, h, is calculated where:

$$h = \frac{c}{d}$$

where c is a user selected scalar value. It may be desirable to clamp the d value to a lower bound of 1 before calculating the h value. The h value represents the intensity of light at the surface point associated with the current pixel. At 35, said distance scalar value, h, is output. In a preferred practice of the present invention, the P vector is output as a 4-dimensional vector with the h value used as the 4^{th} vector component.

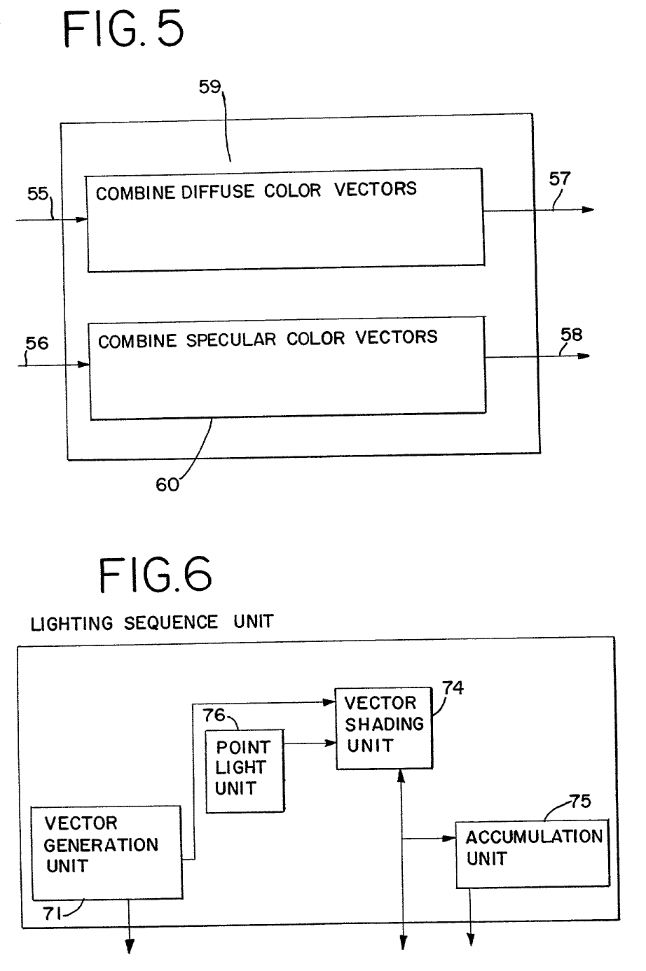

FIG. 4 illustrates the operation of the Vector Shading Unit. At 41 and 42, a light vector, L, and surface vector, S, are input. The light vector may be a user-provided light vector or a point light vector generated from the Point Light Unit. As a preferred practice of the present invention, it is assumed that the L vector is a 4-dimensional vector value where the 4^{th} vector component consists of the aforementioned scalar h value in the case of a point light vector and consists of a user defined scalar value (usually, but not necessarily, 1.0) in the case of a user-provided light vector. The surface vector, S, typically consists of either the surface angle vector, N, or the view reflection vector, R, output by the Vector Generation Unit as previously detailed. However, a user-provided S value may also be used. In either case, the S vector is assumed to be a 4-dimensional vector value. In the case where the S vector is taken as the N or R vectors, as previously described, a value of 1.0 may be taken as the 4^{th} vector component to assure that S is a 4-dimensional vector. In a preferred embodiment, the Vector Shading Unit may be programmed to received the L and S vectors from user-specified hardware registers wherein said registers may be either special-purpose registers designated to hold the output vectors of the Point Light/Vector Generation Units or general-purpose registers in the Programmable Shading Unit.

At 46, a raw scalar dot product value, r, is calculated where:

r=L·S

The r value may be provided for use in the Programmable Shading Unit at 46. At 44, the raw dot product value, r, is optionally scaled. The purpose of this stage is primarily to incorporate the effects of shadows and surface specularity functions. Two scalar values, y and z, may be user-provided. A 2-dimensional specular map may also be specified wherein said map may reside in texture memory or local shader memory. The r and y values are used as a coordinate pair (r,y) to address said specular map which provides a scalar value w. If a specular map is not used, the w value is set equal to r. The w value is then multiplied by the z value producing the scaled dot product value q. At 47, the q value is provided for use in the Programmable Shading Unit. At 45, a 3 or 4-dimensional color vector c is scaled by said q value. Said color vector is user-provided through the Programmable Shading Unit, i.e., a general or special-purpose register may be used to hold said color vector. A resulting color vector e is calculated where:

e=qc

The e value is output at 48.

An alternate embodiment implements the Point Light Unit and Vector Shading Unit as fully programmable hardware elements wherein the sub-tasks of said hardware units may be executed independently through commands from the Programmable Shading Unit. The Point Light and Vector Shading Units should be designed to provide a throughput rate of one operation per clock cycle provided their subtasks operations are performed in a pre-defined sequence.

FIG. 5 illustrates the operations of the Accumulation Unit. The Accumulation Unit is responsible for the combination of specular and diffuse light colors. At 55, one or more diffuse color vectors are input wherein said color vectors are 3 or 4-dimensional vector values. In a preferred practice of the present invention, the Accumulation is configurable to receive diffuse color vectors from a user-defined set of general or special purpose registers. At 59, said diffuse color vectors are combined through vector addition to produce a combined diffuse color vector. Said combined diffuse color vector is output at 57. At 56, one or more specular color vectors are input. At 60, said specular color vectors are combined through vector addition producing a combined specular color vector which is output at 58. Alternate embodiments exclude the Accumulation Unit and allow the user to combine diffuse and specular colors through the Programmable Shading Unit.

After the combined diffuse and specular color vectors are arrived at, the user may use them to modify the pixel color in the Programmable Shading Unit. A preferred embodiment provides dedicated hardware to perform a component-wise multiplication of a surface color vector and the combined diffuse color vector followed by the addition of the combined specular color value. Using dedicated hardware for this task, as opposed to general purpose Programmable Shading operations, allows a standard pixel lighting sequence to be completed at a rate of one pixel per clock cycle (or higher). Alternate embodiments use general purpose Programmable Shading operations to perform diffuse and specular light combination.

The pixel color may be further modified, i.e., to incorporate fogging effects, or directly output from the Programmable Shading Unit as the final pixel color. Practices of the present invention have allowed for configurable per-pixel lighting at rates of one pixel per clock cycle or higher to be achieved in real-time 3D graphics hardware.

The detailed description presented herein is primarily for the purposes of example and, as should be recognized by those skilled in the applicable art, changes and modifications may be made to disclosed implementation without departing from the scope of the present invention as defined by the appended claims and their equivalents.

1. A per-pixel graphics processing unit for use in a system for lighting a plurality of polygon surfaces in a rendering system, the graphics processing unit comprising:
a. dedicated hardware logic operable to perform a sequence of lighting calculations that generate per-pixel lighting equation lighting coefficients for a plurality of the drawn pixels; and
b. per-pixel user programmable hardware logic communicating with the dedicated hardware logic to receive the per-pixel lighting coefficients and perform additional shading calculations using the lighting coefficients.

2. The graphic processing unit of claim 1 wherein the dedicated hardware logic communicates with the programmable hardware logic through one or more shared registers.

3. The graphic processing unit of claim 1 wherein the dedicated hardware logic comprises logic that uses the lighting coefficients in the calculation of a color value.

4. The graphic processing unit of claim 1 wherein the dedicated hardware logic includes a vector generation unit that receives vertex values for the polygon surfaces and calculates a 3-dimensional, unit-length surface normal vector.

5. The graphic processing unit of claim 4 wherein the vector generation unit calculates a 3-dimensional, unit-length view reflection vector.

6. The graphic processing unit of claim 1 wherein the dedicated hardware logic includes a point light unit that calculates normalized point light vectors.

7. The graphic processing unit of claim 6 wherein the point light unit calculates scalar distance coefficients.

8. The graphic processing unit of claim 1 wherein the dedicated hardware logic includes a vector shading unit that performs vector dot product operations.

9. The graphic processing unit of claim 8 wherein the vector shading unit performs color scaling operations.

10. The graphic processing unit of claim 4 wherein the vector generation unit receives a bump map vector and combines the bump map vector with the normal vector to produce a composite surface angle vector.

11. The graphic processing unit of claim 4 wherein the vector shading unit receives eye vector information and generates a view reflection vector therefrom.

12. The graphic processing unit of claim 1 further comprising a texture memory communication with the programmable hardware logic.

13. A per-pixel graphics processing unit for use in a system for lighting a plurality of polygon surfaces in a rendering system, the graphics processing unit comprising:
a. dedicated hardware logic operable to perform a sequence of lighting calculations that generate per-pixel specular lighting value coefficients for a plurality of the drawn pixels; and
b. per-pixel user programmable hardware logic communicating with the dedicated hardware logic to receive the per-pixel lighting coefficients and perform additional shading calculations using the specular lighting value coefficients.

14. The graphic processing unit of claim 13 wherein the dedicated hardware logic communicates with the programmable hardware logic through one or more shared registers.

15. The graphic processing unit of claim 13 wherein the dedicated hardware logic comprises logic that uses the lighting coefficients in the calculation of a color value.

16. The graphic processing unit of claim 13 wherein the dedicated hardware logic includes a vector generation unit that receives vertex values for the polygon surfaces and calculates a 3-dimensional, unit-length surface normal vector.

17. The graphic processing unit of claim 16 wherein the vector generation unit calculates a 3-dimensional, unit-length view reflection vector.

18. The graphic processing unit of claim 13 wherein the dedicated hardware logic includes a point light unit that calculates normalized point light vectors.

19. The graphic processing unit of claim 18 wherein the point light unit calculates scalar distance coefficients.

20. The graphic processing unit of claim 13 wherein the dedicated hardware logic includes a vector shading unit that performs vector dot product operations.

21. The graphic processing unit of claim 20 wherein the vector shading unit performs color scaling operations.

22. The graphic processing unit of claim 16 wherein the vector generation unit receives a bump map vector and combines the bump map vector with the normal vector to produce a composite surface angle vector.

23. The graphic processing unit of claim 16 wherein the vector shading unit receives eye vector information and generates a view reflection vector therefrom.

24. The graphic processing unit of claim 13 further comprising a texture memory communication with the programmable hardware logic.

25. A per-pixel graphics processing unit for use in a system for lighting a plurality of polygon surfaces in a rendering system, the graphics processing unit comprising:
a. dedicated hardware logic operable to perform a sequence of lighting calculations that generate per-pixel diffuse lighting value coefficients for a plurality of the drawn pixels; and
b. per-pixel user programmable hardware logic communicating with the dedicated hardware logic to receive the per-pixel lighting coefficients and perform additional shading calculations using the diffuse lighting value coefficients.

26. The graphic processing unit of claim 25 wherein the dedicated hardware logic communicates with the programmable hardware logic through one or more shared registers.

27. The graphic processing unit of claim 25 wherein the dedicated hardware logic comprises logic that uses the lighting coefficients in the calculation of a color value.

28. The graphic processing unit of claim 25 wherein the dedicated hardware logic includes a vector generation unit that receives vertex values for the polygon surfaces and calculates a 3-dimensional, unit-length surface normal vector.

29. The graphic processing unit of claim 28 wherein the vector generation unit calculates a 3-dimensional, unit-length view reflection vector.

30. The graphic processing unit of claim 25 wherein the dedicated hardware logic includes a point light unit that calculates normalized point light vectors.

31. The graphic processing unit of claim 30 wherein the point light unit calculates scalar distance coefficients.

32. The graphic processing unit of claim 25 wherein the dedicated hardware logic includes a vector shading unit that performs vector dot product operations.

33. The graphic processing unit of claim 32 wherein the vector shading unit performs color scaling operations.

34. The graphic processing unit of claim 28 wherein the vector generation unit receives a bump map vector and combines the bump map vector with the normal vector to produce a composite surface angle vector.

35. The graphic processing unit of claim 28 wherein the vector shading unit receives eye vector information and generates a view reflection vector therefrom.

36. The graphic processing unit of claim 25 further comprising a texture memory communication with the programmable hardware logic.

37. A per-pixel graphics processing unit for use in a system for lighting a plurality of polygon surfaces in a rendering system, the graphics processing unit comprising:
a. dedicated hardware logic operable to perform a sequence of lighting calculations including the calculation of a substantially normalized point light vector; and
b. per-pixel user programmable hardware logic communicating with the dedicated hardware logic to receive the substantially normalized point light vector and perform additional shading calculations.

38. The graphic processing unit of claim 37 further comprising point light data provided to the graphics processing unit.

39. The graphic processing unit of claim 38 wherein the point light data includes a surface position vector and point light position vector.

40. The graphic processing unit of claim 38 wherein point light data for multiple light sources is input into the graphics processing unit in order to produce multiple normalized point light vectors.

41. The graphic processing unit of claim 38 wherein the substantially normalized point light vectors for the multiple light sources are calculated in parallel.

42. The graphic processing unit of claim 38 wherein the dedicated hardware is operable to calculate a dot product.

43. The graphic processing unit of claim 38 wherein the substantially normalized point light vector includes a value that represents the intensity of the light at a surface point of a polygon surface.

44. A per-pixel graphics processing unit for use in a system for lighting a plurality of polygon surfaces in a rendering system, the graphics processing unit comprising:
a. dedicated hardware logic operable to perform a sequence of lighting calculations including the calculation of a surface normal vector; and
b. per-pixel user programmable hardware logic communicating with the dedicated hardware logic to receive the surface normal vector and perform additional shading calculations.

45. The graphic processing unit of claim 44 wherein the dedicated hardware logic communicates with the programmable hardware logic through one or more shared registers.

46. The graphic processing unit of claim 45 wherein the dedicated hardware logic includes a vector generation unit that receives vertex values for the polygon surfaces and calculates a 3-dimensional, unit-length surface normal vector.

47. The graphic processing unit of claim 45 wherein the vector generation unit calculates a 3-dimensional, unit-length view reflection vector.

48. A per-pixel graphics processing unit for use in a system for lighting a plurality of polygon surfaces in a rendering system, the graphics processing unit comprising:
a. dedicated hardware logic operable to perform a sequence of lighting calculations including the calculation of a reflection vector; and
b. per-pixel user programmable hardware logic communicating with the dedicated hardware logic to receive the reflection vector and perform additional shading calculations.

49. The graphic processing unit of claim 48 wherein the dedicated hardware logic communicates with the programmable hardware logic through one or more shared registers.

50. The graphic processing unit of claim 49 wherein the dedicated hardware logic includes a vector generation unit that receives vertex values for the polygon surfaces and calculates a 3-dimensional, unit-length surface normal vector.

51. The graphic processing unit of claim 50 wherein the vector generation unit calculates a 3-dimensional, unit-length view reflection vector.
